(19) United States
(12) Patent Application Publication
(10) Pub. No.: US 2024/0165921 A1
(43) Pub. Date: May 23, 2024

(54) JOINING STRUCTURE AND MANUFACTURING METHOD FOR SAME

(71) Applicant: WASEDA UNIVERSITY, Tokyo (JP)

(72) Inventor: Kohei TATSUMI, Tokyo (JP)

(21) Appl. No.: 18/547,965

(22) PCT Filed: Feb. 28, 2022
(86) PCT No.: PCT/JP2022/008456

§ 371 Date: Aug. 25, 2023

(30) Foreign Application Priority Data
Mar. 1, 2021 (JP) 2021-032158

(51) Int. Cl. B32B 15/01; B23K 20/02; B23K 103/04; B23K 103/18; C23C 18/16; C23C 18/18; C23C 18/32; C25D 3/12; C25D 5/50

(52) U.S. Cl. CPC B32B 15/015; B23K 20/02; B32B 15/017; C23C 18/1637; C23C 18/1692; C23C 18/1806; C23C 18/1837; C23C 18/32; C25D 3/12; C25D 5/50; B23K 2103/05; B23K 2103/18

(57) ABSTRACT

Provided is a joining structure in which two joined bodies composed of metal are firmly joined together with plated metal, and a method for manufacturing the joining structure. The joining structure comprises a first joined body composed of a first metal, a second joined body composed of a second metal, and a plating portion, disposed between the first joined body and the second joined body, formed of a plating metal, and joining the first joined body and the second joined body. In the plating portion a joining interface of plating metal is formed at around equidistance from the respective joined surfaces of the first joined body and the second joined body, and the plating portion comprises, in the vicinity of the joining interface, has a recrystallization region where the plating metal has recrystallized, or a first diffusion region where the plating metal has diffused.

### TECHNICAL FIELD

The technology disclosed in this specification relates to a joining structure and its manufacturing method.

### BACKGROUND ART

As a technology for joining metal materials together as joining structures, techniques such as welding are widely used. However, examples of using plating in metal material joining structures are not known. On the other hand, Patent Document 1 discloses a technique for joining copper chip electrodes and copper chip electrodes with copper lead wires, which are semiconductor devices, using plating mainly composed of nickel. In the technology disclosed in Patent Document 1, the joint is formed by allowing plating solution to flow around the partially contacted state of the chip electrode and lead wire, and plating them.

### CITATION LIST

### Patent Literature

Patent Literature 1: WO 2015/053356 A1

### SUMMARY OF THE INVENTION

### Technical Problem

It is also conceivable to use plating techniques like those in Patent Document 1 for joining other than electrodes or lead wires, for instance, joining two joined bodies formed of metals other than electrodes by plating. However, when using plating for joining purposes other than electrode joining, it is anticipated that the joint strength of the joining structure may be insufficient.

The present invention has been made in view of the above points and aims to provide a joining structure and a manufacturing method of the joining structure in which two joined bodies formed of metals are firmly joined by plating metal.

### Solution to Problem

The joining structure according to the present invention includes a first joined body composed of a first metal, a second joined body composed of a second metal, a plating metal formed between the first joined body and the second joined body, and a plating portion for joining the first joined body and the second joined body. The plating portion has a joining interface where the plating metal converges at a substantially equidistant portion from the joined surfaces of the first joined body and the second joined body, and in the vicinity of the joining interface, the plating metal has a recrystallization region where it has recrystallized, or a first diffusion region where it has diffused.

Another joining structure according to the present invention includes a first joined body composed of a first metal, a second joined body composed of a second metal, a plating metal formed between the first joined body and the second joined body, and a plating portion for joining the first joined body and the second joined body. The boundary between at least one of the first joined body and the plating portion includes a second diffusion region where the metal constituting the at least one of the first joined body and the plating metal has diffused and mixed.

The manufacturing method of the joining structure according to the present invention includes the steps of immersing the first joined body composed of a first metal and the second joined body composed of a second metal in a plating solution, forming a joining interface where plating metal grown from the joined surfaces of the first joined body and the second joined body converges between the first joined body and the second joined body, joining the first joined body and the second joined body with the plating metal in the joining step, and performing heat treatment on the plating metal after the joining step to form a recrystallization region in the joining interface.

Another manufacturing method of the joining structure according to the present invention includes the steps of immersing the first joined body composed of a first metal and the second joined body composed of a second metal in a plating solution, forming a joining interface where plating metal grown from the joined surfaces of the first joined body and the second joined body converges between the first joined body and the second joined body, joining the first joined body and the second joined body with the plating metal in the joining step, and performing heat treatment on the plating metal after the joining step, wherein the heat treatment is performed at a temperature where the melting point of the plating metal is T1 (K) and the heat treatment temperature is T2 (K), and the relationship T2≥ T1×⅓ holds.

### Advantageous Effects of the Invention

The joining structure according to the present invention has a joining interface where plating metal converges at a substantially equidistant portion from the joined surfaces of a pair of joined bodies, and in the vicinity of the joining interface, the plating metal has a recrystallization region where it has recrystallized or a first diffusion region where it has diffused. Therefore, it is possible to prevent or suppress the fracture starting from the joining interface and achieve a joining structure in which two joined bodies formed of metals are firmly joined by plating metal.

### BRIEF DESCRIPTION OF DRAWINGS

FIG. 1 is a schematic cross-sectional view showing the configuration of the joining structure according to the first embodiment.

FIG. 2 is an enlarged sectional view of the essential part of the joining structure.

FIG. 3 is a flowchart illustrating the manufacturing method of the joining structure.

FIG. 4 is a schematic diagram showing the configuration of the joining structure according to the second embodiment.

FIG. 5 is an enlarged side view of the essential part of the joining structure.

FIG. 6 is a top view of the joining structure according to the third embodiment.

FIG. 7 is a cross-sectional view taken along VII-VII in FIG. 6, showing an enlarged sectional view of the essential part.

FIG. 8 is a graph showing the test results of shear testing.

FIG. 9 is a scanning electron microscope (SEM) image of the pre-heat-treated joint and plated portion.

FIG. 10 is an SEM image of the joint and plated portion after heat treatment at 400° C.

FIG. 11 is an SEM image of the joint and plated portion after heat treatment at 700° C.

FIG. 12 is an SEM image of the joint and plated portion after cumulative heat treatment at 400° C. to 800° C.

FIG. 13 is an SEM image of the joint and plated portion after heat treatment at 400° C., along with the results of elemental line analysis.

FIG. 14 is an SEM image of the joint and plated portion after heat treatment at 500° C., along with the results of elemental line analysis.

FIG. 15 is an SEM image of the joint and plated portion after heat treatment at 700° C., along with the results of elemental line analysis.

FIG. 16 is an SEM image of the joint and plated portion after cumulative heat treatment at 400° C. to 800° C., along with the results of elemental line analysis.

FIG. 17 is an enlarged SEM image of the cross-section of the plated portion of a sample without a smoothing process.

FIG. 18 is an enlarged SEM image of the cross-section of the plated portion of a sample with a smoothing process.

FIG. 19 is a schematic diagram illustrating crystal growth in the plated portion of a sample without a smoothing process.

FIG. 20 is a schematic diagram of the joining structure according to the fourth embodiment.

FIG. 21 is a backscattered electron (BSE) image of the joint and plated portion of the joining structure without heat treatment, along with the corresponding electron backscatter diffraction (EBSD) image.

FIG. 22 is a BSE image of the joint and plated portion of the joining structure after cumulative heat treatment at 400° C. to 800° C., along with the corresponding EBSD image.

FIG. 23 is a graph showing the test results of tensile testing.

### DESCRIPTION OF EMBODIMENTS

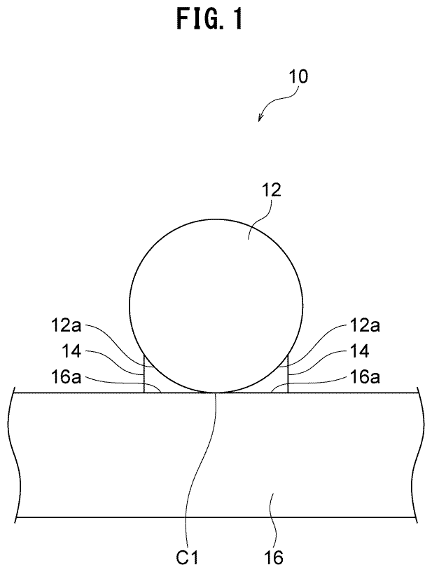

(First Embodiment) As shown in FIG. 1, the joining structure 10 is formed by joining a wire-like first joined body 12 and a plate-like second joined body 16 together using a plating portion 14. The joining structure 10 includes the first joined body 12, the second joined body 16, and the plating portion 14. The first joined body 12 and the second joined body 16 are formed of stainless steel, which is one type of iron-based alloy. The plating portion 14 is made of nickel (Ni) as a plating metal between the first joined body first joined body 12 and the second joined body 16. This plating portion 14 is formed by plating using a plating solution. In this embodiment, the first metal forming the first joined body 12 and the second metal forming the second joined body 16 are the same metal, but they may be different metals.

In this embodiment, an example of a joining structure 10 is described where a wire-like first joined body 12 with a circular cross-section elongated shape is joined to a flat plate-shaped second joined body 16. However, the shape and configuration of the joining structure 10, which includes the first joined body 12 and the second joined body 16, are not limited to this example. The joining structure 10 can be applied to various components, such as pipes of a heat exchanger, pipes joined to a casing, pipes and cooling fins, cooling fins joined to a casing, vacuum containers, gas or liquid piping joints, wire meshes formed by joining wires together, honeycomb structures of stainless steel catalyst carriers, and joining small portions of eyeglass components, etc. In other words, the joining structure enables low-temperature joining by plating instead of conventional welding or brazing. Moreover, although the first joined body 12 and the second joined body 16 are described as independent joined bodies in this embodiment, in some cases, a pair of joined bodies may be considered to be portions facing each other across a partially interrupted annular tube shape (C-shaped in side view). In such cases, a plating portion may be formed between these portions to constitute a joining structure.

The first joined body 12 is fixed on the plate surface of the second joined body 16 in a manner extending along the plate surface of the second joined body 16. In other words, the first joined body 12 contacts the second joined body 16 in a linear fashion along its extending direction, which is orthogonal to the normal direction of the plate surface of the second joined body 16. The first joined body 12 has a joined surface 12a provided on a part of its surface (the part facing the second joined body 16) for joining with the second joined body 16, and the second joined body 16 has a joined surface 16a provided on a part of its surface (the part facing the first joined body 12) for joining with the first joined body 12.

The distance between the joined surfaces 12a and 16a of the first joined body 12 and the second joined body 16 gradually widens from the contact portion C1 between the two joined bodies 12 and 16 and outward. In other words, the two joined surfaces 12a and 16a have their distances continuously increasing as they move away from the contact portion C1 where a part of the joined surfaces 12a and 16a contacts each other. In this way, a plating portion 14 is formed between the joined surfaces 12a and 16a, where the distance widens as it moves outward from the contact portion C1, and this plating portion 14 binds the first joined body 12 and the second joined body 16 together, resulting in the joining of the two bodies.

In this embodiment, the joined bodies 12 and 16 are shown as linearly contacting, but they may also contact each other in a point-like manner, for example, when a roughly spherical first joined body is joined to a plate-like second joined body. Furthermore, the joined bodies 12 and 16 may be in point-like or linear proximity. In other words, the joined surfaces of the joined bodies may have their distances continuously increasing as a part of each joined surface moves away from each other, meaning that the closely approached portion of each joined surface can be considered as point-like or linear contact. It is preferable that the distance between the closely approached portion of each joined surface and the farthest point of each joined surface is ⅕ or less, and even more preferably, 1/10 or less.

As mentioned above, the configuration where the distance between the joined surfaces 12a and 16a widens from the contact portion C1 or its closely approached portion to the outside prevents or suppresses the occurrence of voids at the joining where columnar crystals, grown from each joined surface, meet. This enhances the bonding strength between the first joined body 12 and the second joined body 16.

Furthermore, when two joined bodies, one with an angular columnar shape and the other being plate-like, are joined, or when some parts of the joined bodies are in surface contact or close proximity, it is preferable to have a configuration where the distance between the joined surfaces widens from the contact or closely approached portion. In this case, the boundary between the surface contact or closely approached portion and the portion with the widening distance will become a linear contact or close proximity. Thus, even in this configuration, voids can be prevented or suppressed at the joining where columnar crystals grown from each joined surface meet.

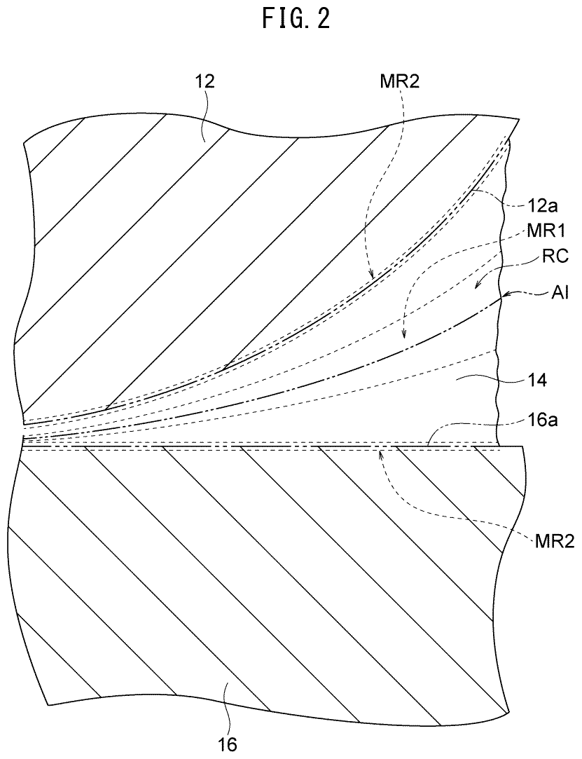

As shown in FIG. 2, in the plating portion 14, the voids are eliminated, and the plating portion 14 is formed without any gaps between the joined surfaces 12a and 16a of the first joined body 12 and the second joined body 16. The plating portion 14 includes a recrystallization region RC formed in a manner crossing the joining interface AI. The recrystallization region RC is a grain region where the columnar crystals of the plating metal (nickel in this embodiment) grown from the joined surfaces 12a and 16a recrystallize and become granular. Note that due to the diffusion of the metal forming the first joined body 12 and the second joined body 16 into the plating portion 14 or the diffusion of the plating metal in the plating portion 14 into the first joined body 12 and the second joined body 16 during the manufacturing process of the joining structure 10, there may be cases where the boundary between the first joined body 12, the second joined body 16, and the plating portion 14, i.e., the joined surfaces 12a and 16a, is not clear. However, in FIG. 2, the joined surfaces 12a and 16a are drawn for convenience.

During the manufacturing process of the joining structure 10, the recrystallization region RC is formed in at least a part of the plating portion 14 where columnar crystals grown from each joined surface 12a and 16a meet and collide (contact) with each other. Through heat treatment in the joining

In the manufacturing process of the joining structure 10, a high-temperature long-time heat treatment is further performed to form recrystallization regions RC in the plating portion 14. These recrystallization regio0ns RC are formed at substantially equidistant portions from each joined surface 12a and 16a. In other words, in the plating portion 14, the plating metal forms granular crystals that recrystallize and extend across the joining interface AI. As a result, the joining interface AI, which would be the starting point of fracture and weaken the plating portion 14, is absent, and the fracture starting from the joining interface AI can be prevented or suppressed. Consequently, the joining structure 10 achieves a strong and robust bonding between the first joined body 12 and the second joined body 16.

In the joining structure 10 of this embodiment, although the recrystallization regions RC are formed in part of the plating portion 14, it is not necessary for the recrystallization regions RC to be formed in the plating portion 14. Even without the recrystallization regions RC, diffusion occurs at the joining interface above the recovery temperature, increasing the interface strength. Through the heat treatment in the manufacturing process, recrystallization (atomic rearrangement) occurs in the plating portion 14. This enables a stronger bond between the first joined body 12 and the second joined body 16. The occurrence of recrystallization can be confirmed, for example, by observing the decrease in Vickers hardness of the plating portion 14 or the formation of subgrains (or subcrystalline structure) in the plating portion 14 or by observing the decrease in dislocation density using electron microscopy.

The recrystallization in the plating portion 14 may be formed only in the vicinity of the joining interface AI, as shown, for example, in FIG. 2, as a first diffusion region MR1. The first diffusion region MR1 is a region where atoms of the plating metal (nickel atoms) constituting the crystals growing from the joined surface 12a of the first joined body 12 and the joined surface 16a of the second joined body 16 diffuse, crossing the joining interface AI.

Even if the recrystallization regions RC are not formed in the plating portion 14, a strong joint can be achieved when the joining structure 10 is in a state where the first diffusion region MR1 is formed near the joining interface AI in the plating portion 14. Therefore, a strong bond between the first joined body 12 and the second joined body 16 can be achieved. If the recrystallization occurs throughout the plating portion 14, the bond between the first joined body 12 and the second joined body 16 can be further strengthened.

As described above, if recrystallization regions RC that extend across the joining interface AI are formed at least in part of the plating portion 14 in the manufacturing process of the joining structure 10, the bond strength between the first joined body 12 and the second joined body 16 can be greatly increased. For example, in the plating portion 14, recrystallization regions RC may be formed only in the vicinity of the joining interface AI, causing the joining interface AI to disappear, and regions (composed of columnar crystals) that do not recrystallize outside the recrystallization regions RC (i.e., on the side of joined surfaces 12a and 16a) may be formed.

It is also possible to achieve a strong bond between the first joined body 12 and the second joined body 16 without performing heat treatment in the manufacturing process of the joining structure 10, or even if the joining interface AI of the plating portion 14 does not disappear as a result of heat treatment. This can be accomplished by preventing or suppressing the occurrence of voids at the joining interface AI due to the uniform growth direction of columnar crystals that grow from each joined surface 12a and 16a. Specifically, if the ratio of the area of a single columnar crystal to the area of the plating portion 14 is 50% or more, good bonding between the first joined body 12 and the second joined body 16 can be obtained. Preferably, if the ratio is 66% or more, the occurrence of voids can be effectively suppressed.

Regarding the crystal orientation of growth, in the case of nickel, <001> and <101> are the preferred growth directions, and even if they coexist, they form columnar crystals. It is preferable that the ratio based on these is 50% or more and more preferably 66% or more. In terms of crystal orientation representation, in the case of cubic crystals, <101>, <110>, and <011> are considered equivalent to each other, as are <100>, <010>, and <001>, and they are treated as the same crystal orientation group.

Furthermore, by performing heat treatment at a temperature above the recovery temperature during the manufacturing process, the joining structure 10 forms a second diffusion region MR2 at the boundary between the first joined body 12 and the plating portion 14 (near the joined surface 12a) and the boundary between the second joined body 16 and the plating portion 14 (near the joined surface 16a). The second diffusion region MR2 at the boundary between the first joined body 12 and the plating portion 14 is a region where atoms of iron or other constituents of the stainless steel constituting the first joined body 12 and nickel atoms of the plating metal constituting the plating portion 14 are mixed. In this second diffusion region MR2, the proportion of iron or other constituents of the stainless steel constituting the first joined body 12 gradually decreases from the first joined body 12 toward the plating portion 14, and the proportion of nickel atoms of the plating metal gradually decreases from the plating portion 14 toward the first joined body 12.

Similarly, the second diffusion region MR2 formed at the boundary between the second joined body 16 and the plating portion 14 is a region where atoms of iron or other constituents of the stainless steel constituting the second joined body 16 and nickel atoms of the plating metal constituting the plating portion 14 are mixed. In this second diffusion region MR2, the proportion of iron or other constituents of the stainless steel constituting the second joined body 16 gradually decreases from the second joined body 16 toward the plating portion 14, and the proportion of nickel atoms of the plating metal gradually decreases from the plating portion 14 toward the second joined body 16.

By forming the second diffusion regions MR2 at the boundaries between the first joined body 12 and the plating portion 14 and between the second joined body 16 and the plating portion 14, the bonding at the boundaries becomes stronger, contributing to the overall robustness of the joining structure 10. For example, when each joined body is made of stainless steel and the plating metal is nickel, it is preferable for these diffusion regions to have a thickness

Furthermore, the joining structure 10 consists of the first joined body 12 and the second joined body 16, both of which are composed of stainless steel, which is one of the iron-based alloys. The plating portion 14 is composed of nickel as a plating metal. Stainless steel contains nickel as an alloying element, and it is believed that as long as it does not exceed the solubility limit, the diffusion of nickel into the stainless steel side will cause minimal degradation due to changes in the crystal structure or precipitates. Copper and nickel are also completely soluble in each other. As both joined bodies are fully soluble, there are no different phases like intermetallic compounds between dissimilar metals. This allows achieving strong joints between the first joined body 12 and the plating portion 14, as well as between the second joined body 16 and the plating portion 14, each with excellent strength. Additionally, both stainless steel and nickel possess excellent corrosion resistance. Therefore, the joining structure 10 can maintain a strong joint for a long period.

In the joining structure 10, the first joined body 12 and the second joined body 16 are made of stainless steel, but the metals constituting the first joined body 12 and the second joined body 16 are not limited to stainless steel. The metals constituting the joined bodies can include various iron-based alloys, copper, or copper alloys, including different types of stainless steel. Similarly, the plating metal constituting the plating portion 14 is not limited to nickel. The plating metal can also include nickel alloys or copper, among others. It is preferable that the metals constituting the joined bodies and the plating metal are either completely soluble in each other, or they have a relatively large solubility limit or are made of the same metal. If the metals constituting the joined bodies and the plating metal are the same, it prevents the formation of different phases through diffusion. Examples of completely soluble combinations include copper and nickel, and gold and silver.

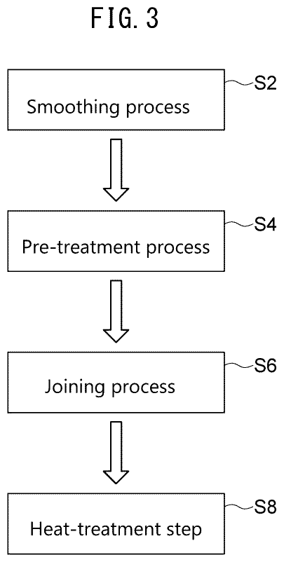

Next, referring to FIG. 3, the manufacturing method of the joining structure 10 according to this embodiment will be described. First, in the smoothing process S2, the first joined body 12 and the second joined body 16 are prepared, and their outer surfaces, including the joined surfaces 12a and 16a of the first joined body 12 and the second joined body 16, respectively, are subjected to mechanical processing or polishing to improve and smooth the surface roughness. The surface roughness of the joined surfaces 12a and 16a of the first joined body 12 and the second joined body 16 after smoothing is preferably an arithmetic average roughness Ra value of 5 μm or less, and more preferably 3 μm or less.

Note that if the joined bodies have surfaces with relatively small surface roughness, such as those in a state of being rolled or drawn, the above smoothing process may not be necessary.

Smoothing the joined surfaces 12a and 16a as described above makes the growth direction of columnar crystals of the plating metal uniform from each of the joined surfaces 12a and 16a. In other words, it ensures that the growth direction of columnar crystals from each of the joined surfaces 12a and 16a does not significantly differ. By doing so, it prevents columnar crystals growing from the outer part of one joined surface 12a from meeting columnar crystals growing from the other joined surface 16a before they meet those growing from the inner part of the former. As a result, it prevents or suppresses the formation of voids in the plating portion 14 by preventing the columnar crystals from the inner part to meet before their growth is stopped.

Next, in the pre-treatment process S4, the surfaces of the first joined body 12 and the second joined body 16 are subjected to alkaline degreasing and acid cleaning to remove dust, oil, and other impurities from the surfaces. Each process of the pre-treatment process S4 can be performed while the second joined body 16 is fixed to the first joined body 12 in the joining configuration or separately when they are apart. The pre-treatment process S4 can be tailored to the materials of the joined bodies and can be omitted if unnecessary.

In the joining process S6 after the pre-treatment process S4, plating treatment is carried out to form the plating portion 14 between the joined surface 12a of the first joined body 12 and the joined surface 16a of the second joined body 16, thereby joining the first joined body 12 and the second joined body 16. The plating treatment is performed by fixing both of them in a state where the first joined body 12 is in linear contact with the second joined body 16 in its extending direction. In other words, the plating treatment is performed with the first joined body 12 and the second joined body 16 fixed in a state suitable for joining. In the plating treatment for the first joined body 12 and the second joined body 16 made of stainless steel, a base plating treatment is performed before the main plating treatment.

In the base plating treatment, the passive film formed on the surfaces of the first joined body 12 and the second joined body 16 is removed, and nickel thin films are formed on their surfaces. For example, a Woods bath (Ni strike plating) can be used as the base plating treatment. The thin film formed in the base plating treatment becomes part of the plating portion 14. If the joined bodies do not require the removal of the passive film, that is, if the joined surfaces have good platability, such base plating treatment may be unnecessary.

In the main plating treatment, for example, a sulfamate bath can be used. This forms the plating portion 14 between the joined surface 12a of the first joined body 12 and the joined surface 16a of the second joined body 16. It is preferable that the temperature of the plating solution during this main plating treatment is about 55° C. When performing the plating treatment in an electrolytic plating process such as the Woods bath or sulfamate bath, it is preferable to electrically connect the first joined body 12 and the second joined body 16 and keep them at the same potential, or electrically short-circuit them at a separate location to ensure electrical continuity.

The plating solution used for the main plating treatment is preferably prepared to promote the meeting of columnar crystals from regions with a small gap between the joined surfaces 12a and 16a to the outer regions sequentially. Additionally, the plating solution used for the main plating treatment preferably does not contain additives that promote the grain refinement, such as brighteners, as this favors the formation of columnar crystals. Therefore, it is desirable to reduce the current density during the main plating treatment. For example, when plating metal refined with brighteners (nickel plating solution) is used to produce a sample, the shear strength did not exceed 50 MPa, and the content of columnar crystals was 20%. In contrast, when no brighteners were used, the shear strength reached at least 100 MPa

When both metals constituting the pair of joined bodies are aluminum, direct electrolytic plating is difficult to achieve. Therefore, after applying a electroless nickel plating of about 0.1 to 10 μm on the joined surfaces of both joined bodies, an appropriate gap is provided between the joined surfaces, and electrolytic nickel plating is grown in the gap to achieve the mating of both joined bodies. In the case of joining aluminum to aluminum, it is preferable to perform heat treatment after plating at a temperature of 200° ° C. to 600° C.

Furthermore, in cases where one of the first joined bodys and the second joined body is composed of aluminum while the other is made of stainless steel, a nickel undercoat is electroless-plated on the joined body made of aluminum, and the joined body made of stainless steel is pre-treated. Subsequently, the two joined bodys are brought into contact and fixed together, and then subjected to an undercoat plating process in a wood bath, followed by the main plating process using a sulfamate bath. This enables the aluminum and stainless steel to be joined together with the plating metal. It should be noted that, in this case, the joined body made of stainless steel may be subjected to undercoat plating before being brought into contact with the other joined body, allowing for both joined bodys to be joined together by performing the main plating process after contact.

In this embodiment, plating is performed over the entire surface of the first joined body 12 and the second joined body 16, but plating treatment may be omitted in parts that do not contribute to the bonding. In this case, before plating treatment, an organic film such as a resist film is applied to the portions (excluding the joined surfaces 12a, 16a) of the surfaces of the first joined body 12 and the second joined body 16 where plating treatment is not needed, thereby enabling selective plating treatment. Alternatively, selective plating treatment can be performed without removing the passive film in the portions of the first joined body 12 and the second joined body 16 where plating treatment is not required.

By performing the plating treatment as described above, elongated nickel columnar crystals grow from each joined surface 12a, 16a. The nickel columnar crystals grown from the joined surfaces 12a of the first joined body 12 and the joined surfaces 16a of the second joined body 16 collide at their tips to form a joining interface AI at substantially equidistant portions from each joined surface 12a, 16a. As a result, the occurrence of voids in the plating part 14 is prevented or suppressed.

Next, in the heat treatment step S8, the structure in which each joined body 12, 16 is joined by the plating part 14 after passing through the joining step S6 (hereinafter referred to as the pre-processed joining structure) is heated. For example, the heat treatment is performed in the atmosphere at 700° C. for 90 minutes. The recrystallization temperature is generally considered to be about ⅓ of the melting point, so it is preferable that the relationship T2≥ T1×⅓ holds, where T1 (K) is the melting point of the plating metal and T2 (K) is the heat treatment temperature for the pre-processed joining structure. For example, in the case where the plating metal is nickel, it is preferable to perform heat treatment at a temperature of 576 K or higher, which is ⅓ of the melting point of nickel. The heat treatment temperature is more preferably 573 K or higher. Of course, it is preferable to set the heat treatment temperature within a range where the performance of the joined bodies 12, 16 and the plating part 14 does not deteriorate. In the case of the present embodiment, where the joined bodies 12, 16 are stainless steel and the plating metal is nickel, the heat treatment temperature is preferably 300° C. to 1150° C.

By the above-mentioned heat treatment, recovery (atomic rearrangement) occurs in the plating part 14, and a first diffusion region MR1 is formed in the vicinity of the joining interface AI, and a second diffusion region MR2 is formed at the interface between the plating part 14 and each joined body 12, 16. In a higher temperature range, columnar crystals are recrystallized into fine-grained crystals to form a recrystallization region RC. For example, in the case where the plating metal is nickel, by heating the pre-processed joining structure at a heat treatment temperature of 250° C. or higher, the atoms of iron or the like constituting the first joined body 12 at the boundary portion (in the vicinity of the joined surface 12a) between the first joined body 12 and the plating part 14 are diffused toward the plating part 14, and the atoms of the plating metal (nickel atoms) constituting the plating part 14 are diffused toward the first joined body 12. Furthermore, at the boundary portion (in the vicinity of the joined surface 16a) between the second joined body 16 and the plating part 14, the atoms of iron or the like constituting the second joined body 16 are diffused toward the plating part 14, and the atoms of the plating metal (nickel atoms) constituting the plating part 14 are diffused toward the second joined body 16. As a result, a second diffusion region MR2 is formed at each boundary portion between the first joined body 12 and the plating part 14 and between the second joined body 16 and the plating part 14.

It should be noted that the recovery (atomic rearrangement) at the joining interface of the plating part 14 causes a decrease in Vickers hardness in the plating part 14. For example, in the case where the plating metal is nickel, when the hardness symbol is HV0.025, the Vickers hardness after heat treatment is about 220 to 120 HV, while the Vickers hardness before heating is about 280 HV. The Vickers hardness of the plating part 54 can be measured using a known measurement method according to Japanese Industrial Standard JIS Z 2244, using a micro Vickers.

Also, in the case where the plating metal is nickel, by heating the pre-processed joining structure at a heat treatment temperature of 250° C. or higher, columnar crystals are recrystallized into fine-grained crystals to form a recrystallization region RC. This change to fine-grained crystals (recrystallization) starts from the joining interface AI where stress is strongly applied to the plating part 14 and can be made wider by increasing the heating time or the like. The size of the recrystallization region can be adjusted by adjusting the heat treatment temperature and heating time.

By the above-described process, the joining structure 10 is manufactured, and the joint of the first joined body 12 and the second joined body 16 is firmly achieved.

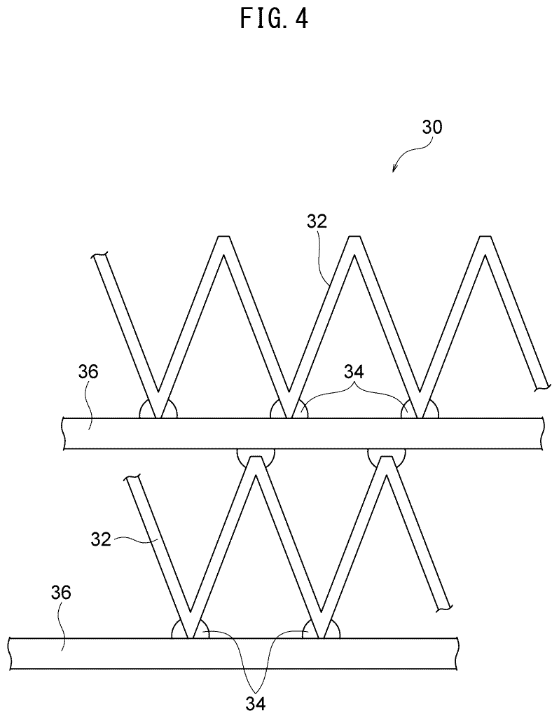

(Second Embodiment) As shown in FIG. 4, the joining structure 30 according to the second embodiment is obtained by joining a first joined body 32 and a second joined body 36, which are alternately arranged in a substantially M shape, by a plating part 34. Other than the detailed description below, it is the same as the first embodiment.

The joining structure 30 is used, for example, as a honeycomb-shaped metal carrier for exhaust gas purification, which is attached to the exhaust pipe of an automobile or motorcycle. The first joined body 32 and the second joined body 36 are arranged alternately in the radial direction and wound in a concentric circular form. The first joined body 32 and the second joined body 36 are formed by bending a strip of ferritic stainless steel, which is one type of iron-based alloy, into a predetermined shape. The plating section 34 is formed between the first joined body 32 and the second joined body 36 by plating with plating liquid, and it is made of nickel (Ni) as the plating metal. It should be noted that in this embodiment, the first metal forming the first joined body 32 and the second metal forming the second joined body 36 are the same metal, but they may be different metals.

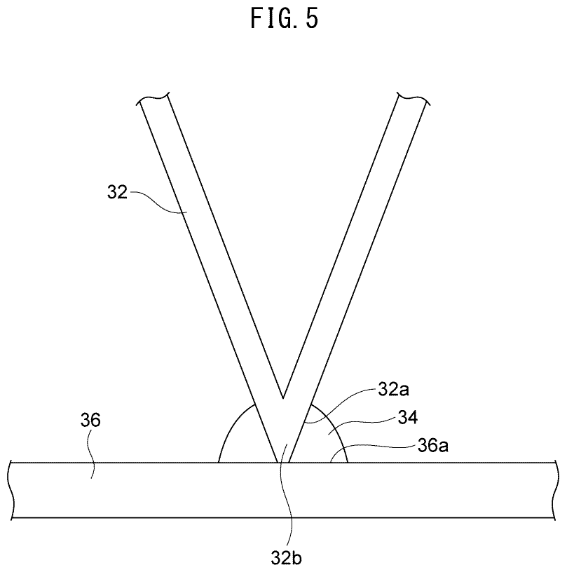

The first joined body 32 has bending portions that bend in the shape of the letter “M,” each of which is in proximity to the second joined body 36 and fixed to it. Since the first joined body 32 and the second bonded body 36 have width in the depth direction of the drawing, the bending portion of the first joined body 32 comes into linear contact with the second joined body 36. As shown in FIG. 5, the tip portion 32b of the bending portion of the first joined body 32 forms a joined surface 32a for bonding with the second joined body 36, and the second joined body 36 has a surface in the area of contact with the first joined body 32, which becomes a joined surface 36a for joining with the first joined body 32.

As shown in FIG. 5, the spacing between the joined surface 32a of the first joined body 32 and the joined surface 36a of the second joined body 36 gradually widens outward from the tip portion 32b of the bending portion of the first joined body 32. In other words, the spacing between both joined surfaces 32a and 36a continuously increases as they move away from the position of the tip portion 32b. Accordingly, a plating portion 34 is formed between the joined surface 32a and the joined surface 36a, with the spacing gradually increasing outward from the tip portion 32b. The plating portion 34 binds the first joined body 32 and the second joined body 36, achieving their joining.

The joining structure 30 achieves a strong and robust bond between the first joined body 32 and the second joined body 36 by being manufactured using the same process as the joining structure of the first embodiment. In the joining process, plating portion 34 is formed by circulating plating solution between the first joined body 32 and the second joined body 36, making it easy to bond the first joined body 32 and the second joined body 36.

As for the aforementioned metal carrier for exhaust gas purification, joining structure s are known in which joined bodies formed of stainless steel are joined together in a vacuum through brazing, or in which joined bodies formed of ceramics are joined together. However, the former method involving brazing in a vacuum is associated with high manufacturing costs, while the latter method using ceramics leads to increased pressure loss. In contrast, the joining structure 30 maintains an equivalent joint strength to that of the conventional metal carrier joined by brazing while reducing manufacturing costs and preventing or suppressing an increase in pressure loss.

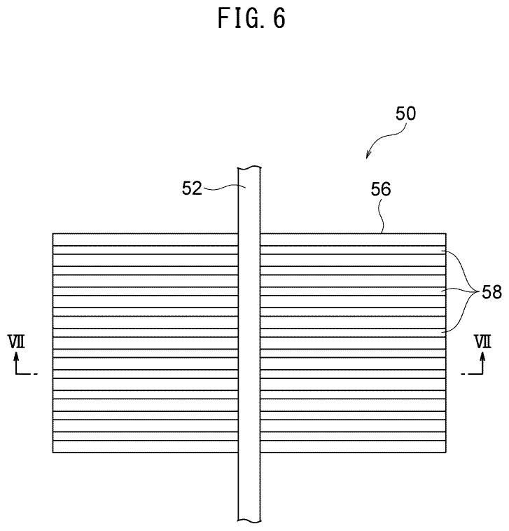

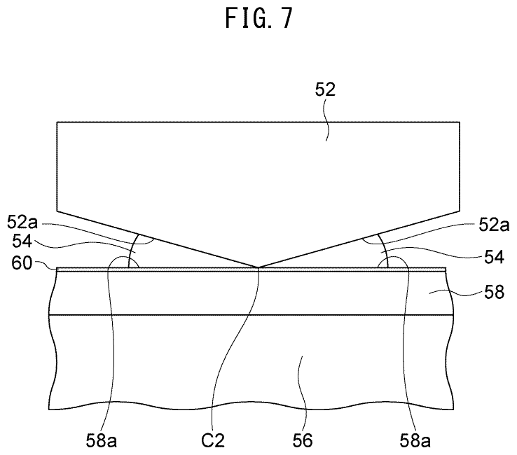

(Third Embodiment) In the third embodiment, a joining structure 50 is explained in which a metal wiring material and a metal surface of a solar cell are joined together by a plating portion. As shown in FIGS. 6 and 7, the joining structure 50 includes a wiring material 52 extending in a strip shape as one of the joined bodies and electrodes 58 formed on the surface of the solar cell 56 as the other joined body, which are joined together by the plating portion 54. FIG. 6 shows one solar cell 56, but in practice, multiple solar cells 56 are connected by wiring materials 52 joined by the plating portion 54 to form a solar cell module. In this embodiment, one of the solar cell 56 and the wiring material 52 is the first joined body, and the other is the second joined body. The description hereafter is the same as in the first embodiment.

The wiring material 52 is made of copper and is used to electrically connect multiple solar cells 56. The solar cells 56 are primarily made of silicon and are of a flat plate shape. The plating portion 54 is formed between the wiring material 52 and the solar cells 56 by plating using a plating solution, with nickel (Ni) being used as the plating metal.

The solar cell 56 has multiple electrodes 58 formed on one of its surfaces. The multiple electrodes 58 extend linearly in a direction perpendicular to the extension direction of the wiring material 52 and are spaced apart from each other at regular intervals in the extension direction of the wiring material 52. The wiring material 52 is locally bonded to only the portions where it intersects the electrodes 58 of the solar cell 56, not bonded to the entire surface facing the solar cell 56. That is, the wiring material 52 is locally bonded to the solar cell 56.

By locally bonding the wiring material 52, the stress applied to the plating portion 54 is effectively alleviated compared to the configuration where the entire surface facing the solar cell 56 is bonded, which leads to an improved durability of the plating portion 54. Therefore, the joining structure 50 is characterized by an extended lifespan compared to conventional solar cell modules.

As shown in FIG. 7, the wiring material 52 protrudes in a mountain shape on the side where its cross-section contacts the electrodes 58 of the solar cell 56, and its peak is in contact with the electrodes 58 when joined. The peak of the wiring material 52 extends linearly in the extension direction, ensuring a linear contact with the electrodes 58. Additionally, as long as the peak of the wiring material 52 is within a certain range and in proximity to the electrodes 58 in the extension direction of the wiring material 52, it is considered acceptable even if some or all of the peak of the wiring material 52 is away from the electrodes 58. The wiring material 52 has a surface area surrounding the peak that serves as the joined surface 52a with the electrodes 58 of the solar cell 56, and the electrodes 58 of the solar cell 56 are covered with silver paste 60 that is sintered, and some of its surface serves as the joined surface 58a for joining with the wiring material 52.

The spacing between the joined surface 52a of the wiring material 52 and the joined surface 58a of the electrodes 58 of the solar cell 56 gradually increases from the contact portion C2 where the peak of the wiring material 52 contacts the electrodes 58 of the solar cell 56 towards the outside. In other words, the spacing between the two joined surfaces 32a and 36a continuously increases as it moves away from the contact portion C2.

The joining structure 50 is manufactured using the same steps as in the first embodiment, except for the heat treatment process. A wood bath is not required. The plating portion 54 is formed in a state where generation of voids between the joined surface 52a of the wiring material 52 and the joined surface 58a of the electrodes 58 of the solar cell 56 is prevented or suppressed. As a result, the joining between the wiring material 52 and the solar cell 56 is in good condition.

In this way, the joint of the wiring material 52 and the solar cell 56 is achieved by replacing the conventional solder joint with a plating portion 54 formed of nickel plating metal instead of solder. The nickel used in the plating portion 54 exhibits less difference in thermal expansion coefficient from the copper material of the wiring material 52 than the difference between solder and copper, which makes the plating portion 54 less susceptible to deterioration and prevents issues such as peeling of the wiring material 52 due to thermal changes.

In the manufacturing process of the joining structure 50 where the wiring material 52 and the solar cell 56 are joined, it is preferable to perform a heat treatment for the purpose of either not conducting a heat treatment or relieving (removing or reducing) the strain in the plating portion 54. By relieving the strain in the plating portion 54 through heat treatment, flexibility can be imparted to the plating portion 54, i.e., the joint between the wiring material 52 and the electrodes 58. This helps to suppress the destruction of the plating portion 54 caused by the expansion and contraction of the wiring material 52 and the solar cell 56 during use, leading to an improved lifespan of the solar cell module.

Regarding the above-mentioned heat treatment, it is preferable to perform it at a temperature range of 250° C. to 800° ° C. when the plating metal is nickel, for example. The removal or relaxation of strain in the plating portion 54 can be confirmed by a decrease in Vickers hardness. Specifically, when the plating metal is nickel, the Vickers hardness before heating is approximately 280 HV, while after heat treatment, it becomes approximately 220 to 120 HV when using a hardness symbol of HV 0.025. The Vickers hardness of the plating portion 54 can be measured using a well-known measurement method in accordance with Japanese Industrial Standard JIS Z 2244 by micro-Vickers.

### Example 1

(1) Preparation of samples: In the first example, multiple samples of a joining structure were prepared by joining a pair of joined bodies formed of stainless steel using the plating portion, and the joint strength and observation/analysis of the joining interface were conducted. Two joined bodies made of SUS304 stainless steel were prepared. The first joined body was in the form of a wire with a diameter of 0.5 mm and a length of 2 mm, and the second joined body was a flat plate with a thickness of 0.5 mm. Nickel was used as the plating metal constituting the plating portion. The preparation method of the samples was the same as in the above first embodiment.

In the preparation of the samples, the first joined body and the second joined body were first subjected to a smoothing treatment to improve the surface roughness of the first joined body and the second joined body. Next, as a pre-treatment, the stainless steel on the surface of the first joined body and the second joined body was subjected to alkaline degreasing and acid cleaning to remove dust, oil, and other contaminants from the surface. Then, as the joining process, the first joined body was fixed in contact with the second joined body in a linear manner, and a base plating treatment was performed in a wood bath, followed by main plating treatment in a sulfamate bath, to join the first joined body and the second joined body with the plating portion. The plating conditions were set with a plating solution temperature of 55° C., a plating current density of 1.5 A/dm², and a plating width of 0.3 mm.

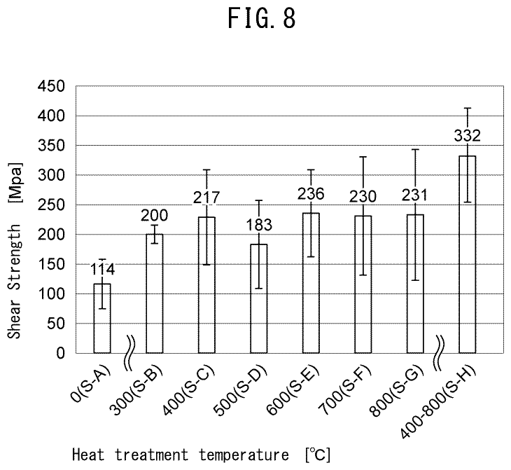

(2) Shear test: To evaluate the joint strength of each sample, a shear test was performed, where the first joined body was peeled off from the second joined body, and the shear strength (MPa) was measured. A Nordson Shear Tester 4000Plus was used for the measurement of the joint strength. The shear test was performed ten times for each sample, and the average value was determined. The measurement results of the shear strength for each sample are shown in FIG. 8.

Based on the measurement results of the shear strength, it was confirmed that for each single temperature sample with a heat treatment temperature ranging from 300° C. to 800° C., the joint strength increased compared to the samples that did not undergo heat treatment. From these results, it was observed that by conducting heat treatment at a temperature of 576K)(303° ° C. or higher, which is one-third of the melting point of nickel (1728K), an effective recrystallization region was formed in the plating portion, resulting in a strong joint between the first joined body and the second joined body. Additionally, for the cumulative heat treatment samples, the joint strength increased to approximately three times that of the samples that did not undergo heat treatment, indicating a significant effect of the heat treatment.

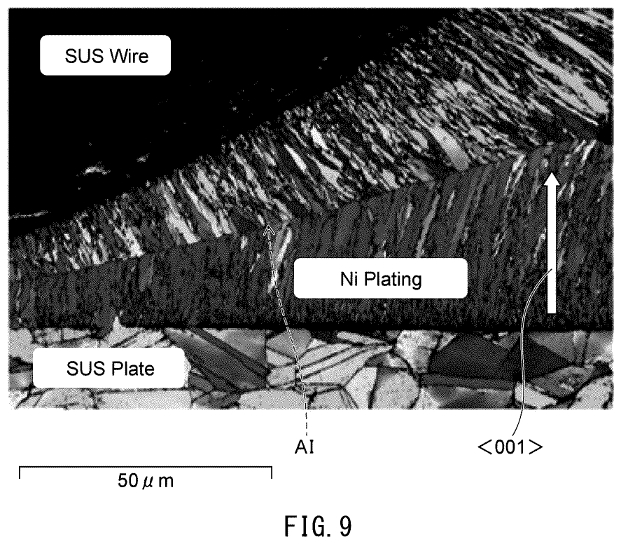

(3) Observation of crystals in the joining interface: First, samples that did not undergo heat treatment were observed with a scanning electron microscope (SEM) to view the plating portion and its vicinity of the cross-section (joining interface). The observation was conducted using a Hitachi SU5000, and the crystal orientation was measured by electron backscatter diffraction (EBSD). As shown in FIG. 9, it was confirmed that pillar-like crystals uniformly grew from the joined surfaces of both the first joined body and the second joined body. The crystal growth from the joining interface of the second joined body was mainly oriented in the <001> direction, and the area ratio was 80% or more. It was confirmed that when the area ratio of such pillar-like crystals is 50% or more, preferably 66% or more, the generation of voids can be effectively suppressed, resulting in a favorable joint.

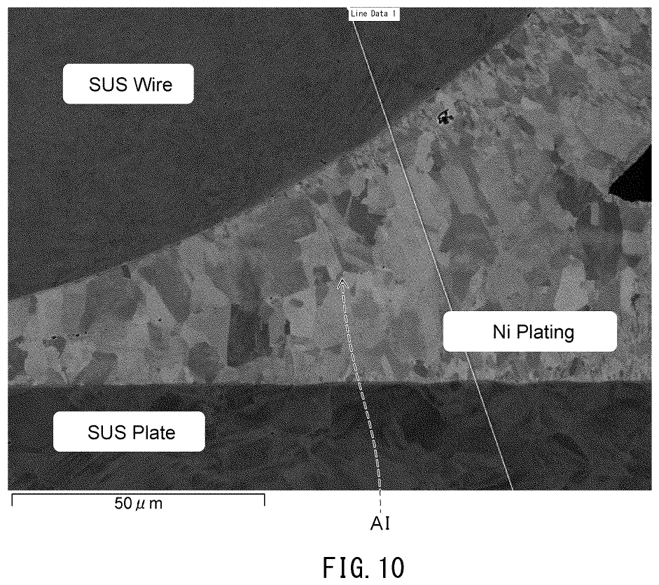

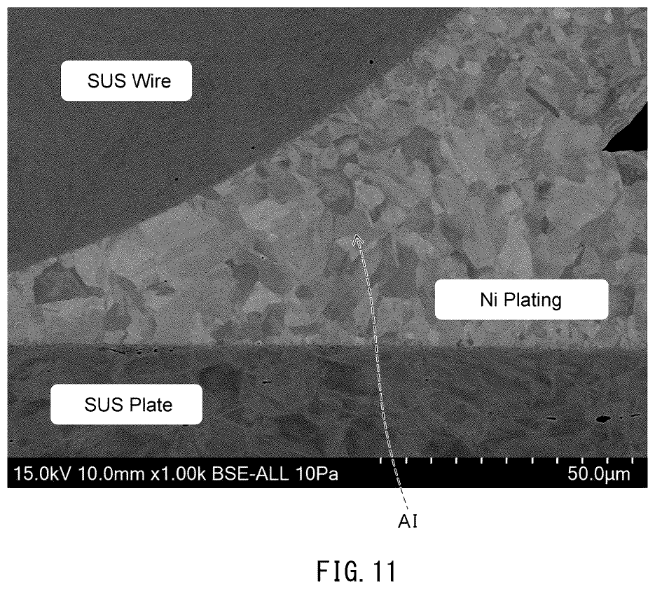

Next, each sample subjected to heat treatment was observed with a scanning electron microscope (SEM) to view the plating portion and its vicinity of the cross-section (joining interface). As shown in FIG. 10, in the single temperature sample heat-treated at 400° C., it was not possible to confirm pillar-like crystals, and most of the grain boundaries (interface AI) had disappeared. From this, it was found that the nickel in the plating portion recrystallized to form granular crystals bridging the grain boundaries (interface AI), resulting in a strong joint. Additionally, as shown in FIG. 11, in the single temperature sample heat-treated at 700° C., the disappearance of the grain boundaries (interface AI) was more advanced compared to the sample heat-treated at 400° C., almost completely disappearing. It was confirmed that the recrystallization progressed more compared to the single temperature sample heat-treated at 400° C. Moreover, in the single temperature sample heat-treated at 700° C., the boundary lines between the first joined body and the plating portion, and between the second joined body and the nickel portion became unclear. From this, it was understood that the diffusion of iron and other atoms constituting the first joined body and the diffusion of nickel atoms constituting the plating portion progressed more at the higher temperature of 700° C.

Furthermore, as shown in FIG. 11, in the single-temperature samples subjected to heat treatment at 700° C., the disappearance of the solid-solution boundary AI is more advanced compared to the samples heat-treated at 400° C., and the recrystallization is found to be more progressed than in the samples heat-treated at 400° C. Also, in the single-temperature samples heat-treated at 700° ° C., the boundaries between the first joined body and the plating section, as well as between the second joined body and the nickel section, are indistinct, unlike in the samples heat-treated at 400° C. This indicates that diffusion of iron and other atoms constituting the first and second joined bodies into the plating section, and diffusion of nickel atoms constituting the plating section into the first and second joined bodies have more extensively occurred due to the higher heat treatment temperature.

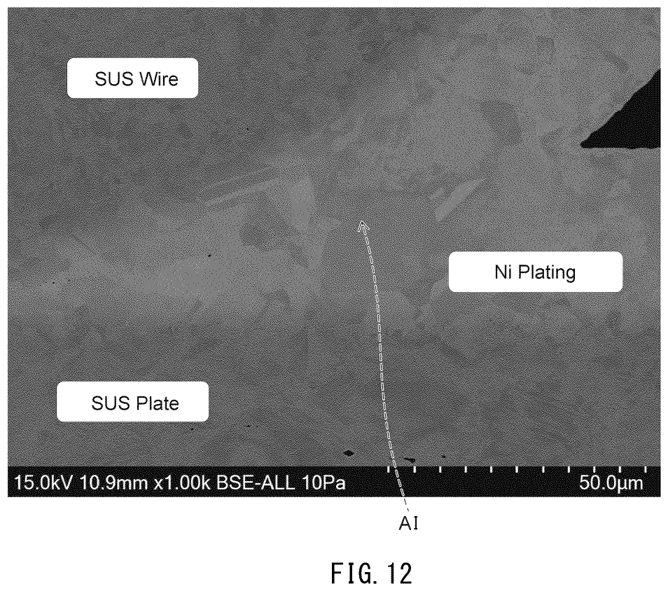

Moreover, in the cumulative heat-treated samples, as shown in FIG. 12, the solid-solution boundary AI is almost completely undetectable in comparison to the single-temperature samples heat-treated at 700° C., indicating that recrystallization has further progressed. Also, in the cumulative heat-treated samples, the boundaries between the first joined body and the plating section, as well as between the second joined body and the plating section, are indistinct to the point of being undetectable, unlike in the single-temperature samples heat-treated at 700° C. This confirms that diffusion of iron and other atoms constituting the first and second joined bodies into the plating section, and diffusion of nickel atoms constituting the plating section into the first and second joined bodies have more significantly advanced in the cumulative heat-treated samples.

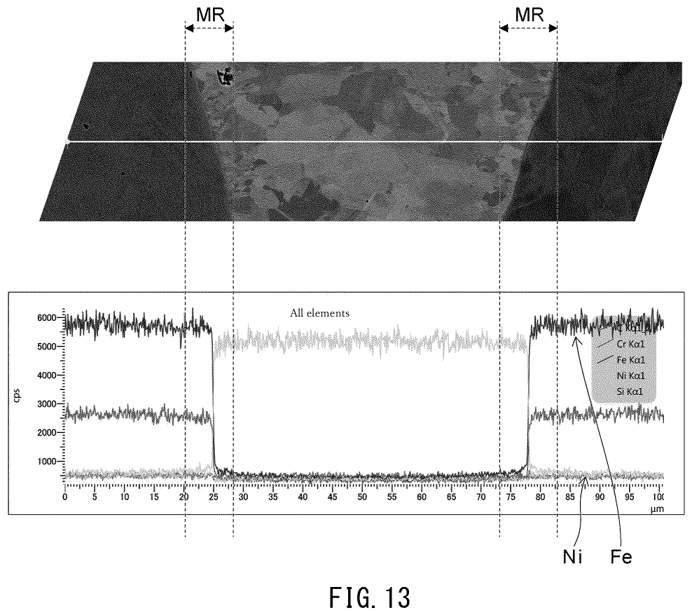

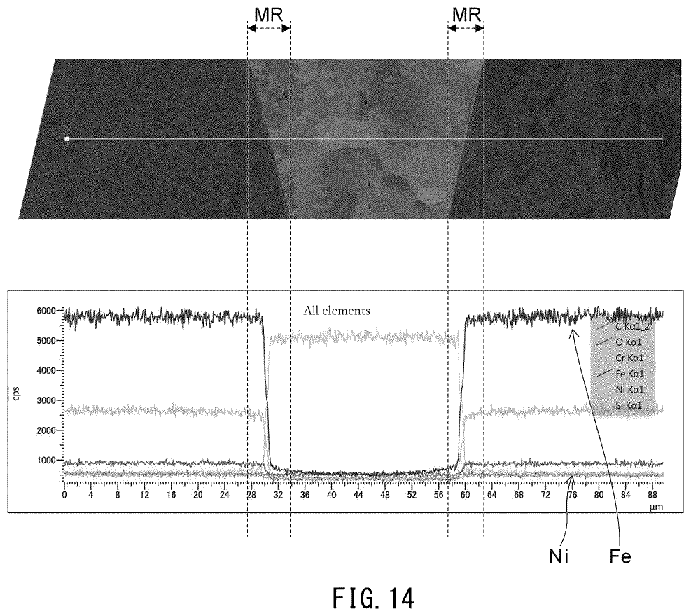

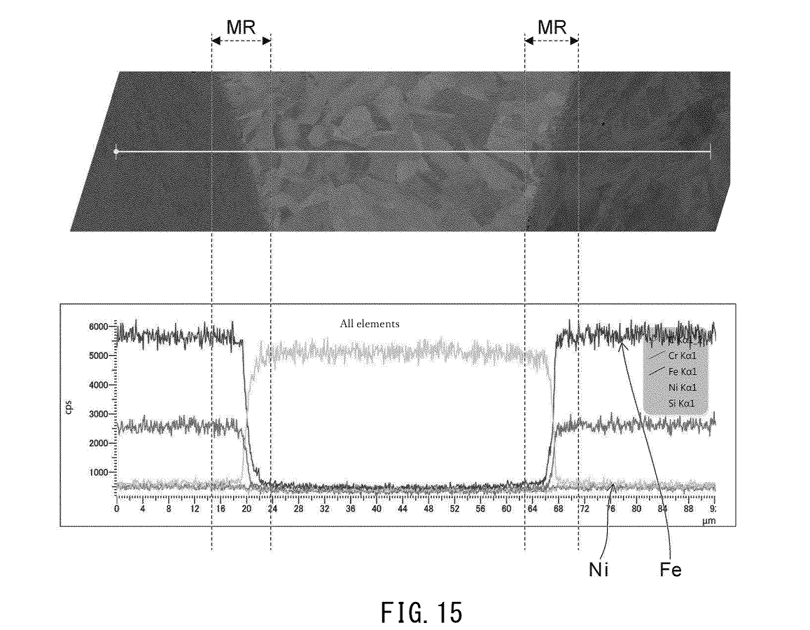

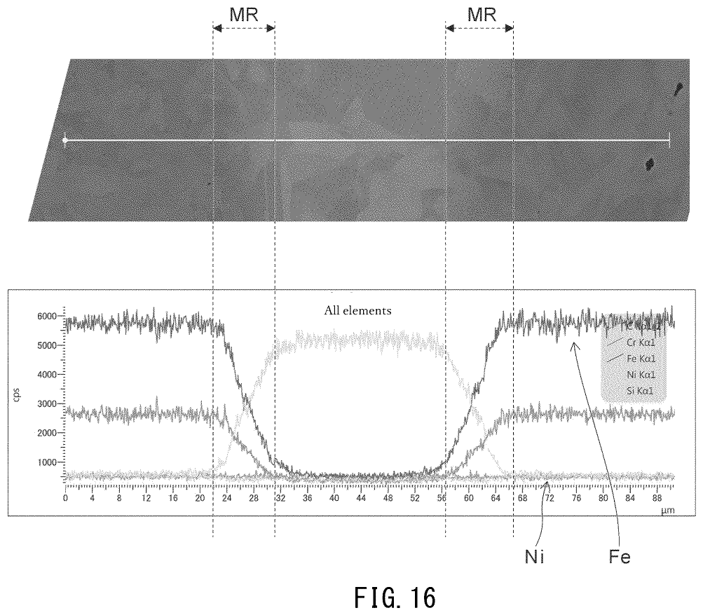

(4) Analysis of the Joining Section: For each sample subjected to heat treatment, the diffusion of elements at the plating section and its vicinity (joining section) was measured using energy-dispersive X-ray analysis (EDX), and elemental line analysis was performed. EDX and elemental line analysis were conducted using an Oxford AZtecXmax50 instrument. The results are shown in FIG. 13 through FIG. 16. FIG. 13 shows the measurement results for the single-temperature sample heat-treated at 400° C., FIG. 14 for the single-temperature sample heat-treated at 500° C., FIG. 15 for the single-temperature sample heat-treated at 700° ° C., and FIG. 16 for the cumulative heat-treated sample.

In the single-temperature sample heat-treated at 400° C., the slope of the fluorescence X-ray intensity of iron and nickel atoms in the diffusion region MR, which includes the boundary between the first joined body and the plating section, as well as the boundary between the second joined body and the plating section, is almost vertical (i.e., the slope is large). This indicates that although some diffusion of iron and other atoms constituting the first and second joined bodies into the plating section and vice versa has occurred, it has not significantly advanced in the sample heat-treated at 400° C.

In the single-temperature sample heat-treated at 500° C., the slope of the fluorescence X-ray intensity in the diffusion region MR is smaller than that in the sample heat-treated at 400° C., indicating that diffusion of iron and other atoms constituting the first and second joined bodies into the plating section and vice versa has progressed. In the single-temperature sample heat-treated at 700° ° C., the slope of the fluorescence X-ray intensity is smaller than that in the sample heat-treated at 500° C., indicating that diffusion has further progressed compared to the case of heat treatment at 500° C.

Furthermore, in the cumulative heat-treated sample, the slope of the fluorescence X-ray intensity in the diffusion region MR is even smaller than that in the single-temperature sample heat-treated at 700° C. This confirms that in the cumulative heat-treated sample, diffusion of iron and other atoms constituting the first and second joined bodies into the plating section and vice versa has even more significantly advanced compared to the single-temperature sample heat-treated at 700° C.

### Example 2

In the second example, a sample of an joined structure was created by joining a pipe-shaped first joined body, formed of stainless steel and open at both ends, with a lid-shaped second joined body at one end using the plating section. A vacuum pull was performed from the other end of the open pipe, and a leak test was conducted to evaluate the effectiveness of the joint with the lid for the pipe. The pipe-shaped first joined body used had an outer diameter of 15 mmφ and an inner diameter of 8.3 mm, and the plating section was made of nickel.

The angular portion of the closed end of the lid-shaped second joined body was tapered from the outside to the inside at a length of 0.5 mm and a taper angle of 20°. Next, pre-treatment was performed on both the first joined body and the second joined body to remove surface dust and oil. The pre-treatment conditions were the same as in the first embodiment. Subsequently, with one end of the first joined body closed by the lid-shaped second joined body, the sample was immersed in the plating liquid of nickel (Ni) to form the plating section in the gap formed by the taper processing. Plating treatments were performed on the first sample, continuously for 90 minutes in a sulfamate bath, and on the second sample, for 60 minutes in the sulfamate bath followed by a temporary removal from the plating liquid and then another 30 minutes in the sulfamate bath. The other plating treatment conditions were the same as in the first embodiment.

A leak test was conducted on each of the prepared samples. As a result of the leak test, it was confirmed that the first sample exhibited sufficient joint strength and a well-formed joint. The second sample showed a further reduction in the amount of leakage. These leak test results indicate that the joining structure formed by plating can be applied not only for applications that require joint strength but also for metal vacuum containers, liquid containers, cooling pipes, etc. It was observed that there was no significant change in the amount of leakage before and after heat treatment for both the first and second samples.

It is preferable that the taper angle, which is the angle formed by the joined surfaces of the first and second joined bodies, is within the range of 2º to 25° in the second embodiment, although not limited to the samples used in the second embodiment. A taper angle that is excessively large increases the angular deviation at the solid-solution boundary, making it more likely to cause voids and potentially leading to thicker plating and longer plating time. Therefore, a taper angle of 25° or less is preferable, and even more preferably, it is 15° or less. Conversely, if the taper angle is excessively small, it becomes difficult for the plating liquid to flow in. Therefore, a taper angle of 2° or more is preferable, and even more preferably, it is 5° or more.

### Example 3

In the third example, samples were prepared for the same first joined body and second joined body as in the second example. Prior to pre-processing, some samples underwent a smoothing treatment to improve surface roughness on each joined surface, while others did not receive this treatment. After the plating process on these samples, observations of the near-plating section on each joined surface were made to examine the differences in crystal growth. The smoothing treatment was conducted using the Buehler AutoMet 250 automatic polishing apparatus to achieve an arithmetic average surface roughness (Ra value) of less than 3 μm on each joined surface.

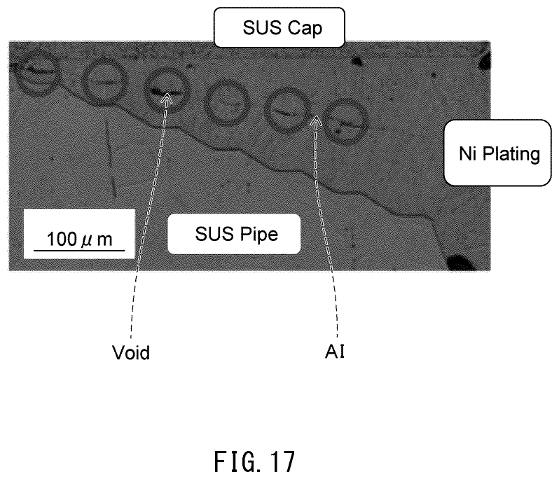

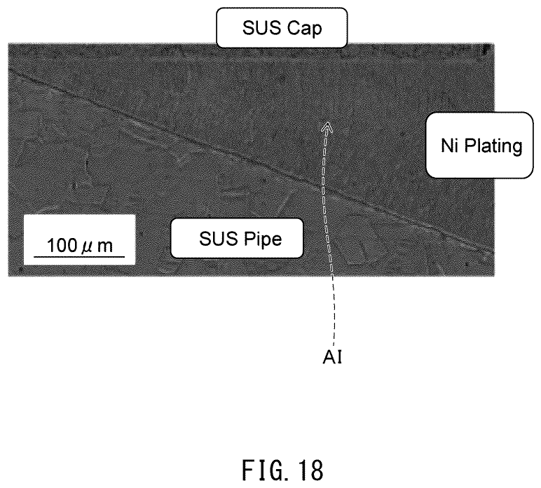

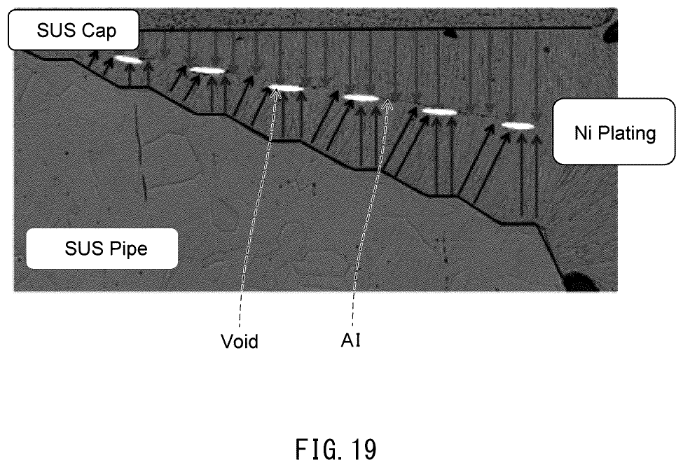

As a result of the observation, it was confirmed that in the samples not subjected to the smoothing treatment but left as machined, multiple voids were present at the joining interface AI, as shown in FIG. 17. On the other hand, in the samples subjected to the smoothing treatment, as shown in FIG. 18, no voids were observed at the joining interface AI. From these observations, it was inferred, as shown in FIG. 19, that in cases where the surface roughness of the joined surface was not improved (i.e., large surface roughness), even if columnar crystals grow uniformly from each joined surface, their growth directions would not be uniformly parallel. Consequently, locally, some columnar crystals growing from one joined surface would meet the columnar crystals growing from the other joined surface before meeting those growing from the inner part, resulting in the growth of the inner part's columnar crystals being halted before they meet at the joining interface AI, leading to the formation of voids.

### Example 4

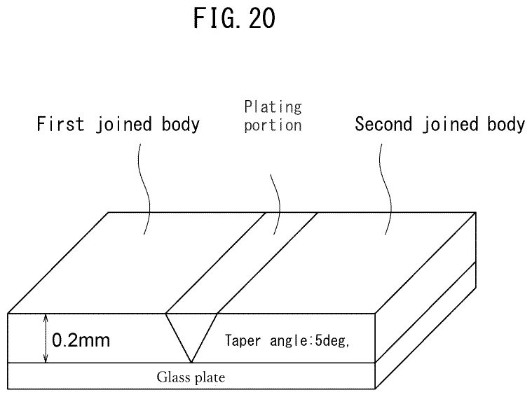

In the fourth example, as shown in FIG. 20, samples were prepared for a flat plate-like first joined body and a second joined body formed from stainless steel, and their joining interfaces were analyzed. The first and second joined bodies were composed of SUS304 stainless steel. Both joined bodies had a thickness of 0.2 mm, and the plating metal used for the plating part was nickel. The preparation method of the samples was the same as in the first embodiment.

In the fabrication of the samples, first, one side of the first joined body and one side of the second joined body were both subjected to taper processing so that they became inclined in cross-section view. Taper processing was performed so that when the front end portions of the taper processed one side of the first joined body and one side of the second joined body were brought into line contact, the taper angle formed by the first joined body and the second joined body became 5 degrees. Next, as a pre-processing step, the stainless steel surfaces of both the first and second joined bodies were subjected to alkali degreasing and acid cleaning to remove any dust or oil on their surfaces.

Next, as the joining process, both the first joined body and the second joined body were fixed together by placing them flat on a glass plate with the front end portions of the taper-processed one side of the first joined body and one side of the second joined body brought into line contact. Under this condition, the samples were subjected to an undercoating process in a wood bath, followed by the main plating process in a sulfamate bath, thereby joining the first joined body and the second joined body with the plating part. The plating conditions were set at a bath temperature of 55° C., a current density of 1.5 A/dm2, and a plating width of 0.2 mm, covering the entire thickness direction of the plate.

After the plating process, the samples were subjected to heat treatment in air. To verify the difference in joint strength due to the heat treatment temperature, samples were prepared by not performing heat treatment and performing sequential heat treatments at each temperature from 400° ° C. to 800° C. in 100° C. increments for 90 minutes.

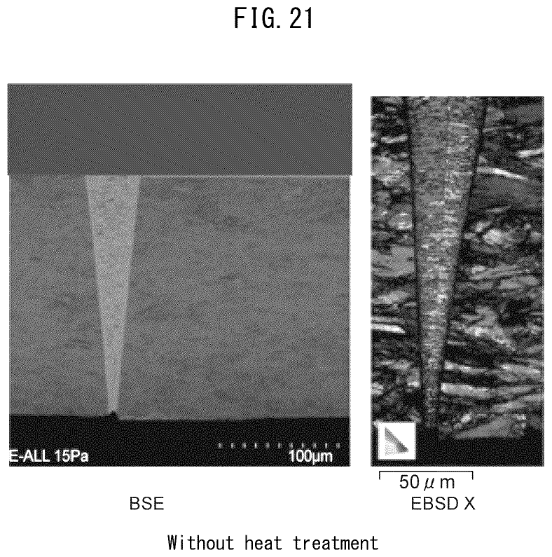

First, for the samples that were not subjected to heat treatment, the plating part and its near-plating section (joining interface) were observed using a scanning electron microscope (SEM). Observation was performed using a Hitachi SU5000, and the crystal orientation was measured by electron backscatter diffraction (EBSD). As shown in FIG. 21, it was confirmed that columnar crystals were uniformly grown from each joined surface of both the first and second joined bodies.

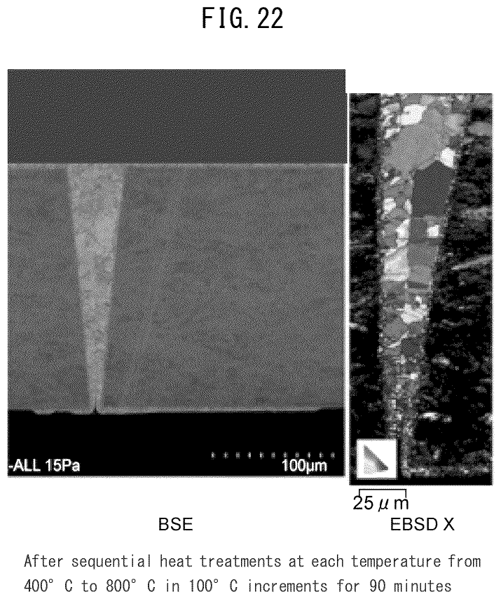

Next, for the samples subjected to heat treatment, the plating part and its near-plating section (joining interface) were observed using a scanning electron microscope (SEM). As shown in FIG. 22, it was observed that the samples subjected to heat treatment did not exhibit columnar crystals, but instead, grainy crystals were present, and most of the joining interface had disappeared. From this observation, it can be concluded that nickel constituting the plating part re-crystallized, spanning the joining interface, resulting in the formation of grainy crystals. It should be noted that in cases where flat plate-like joined bodies are joined with each other, for example, by bringing one or both of the ends of both joined bodies into contact or proximity so that the center in the plate thickness direction becomes the top of a mountain shape toward the opposite side, they can be joined with the present invention.

### Example 5

In the fifth example, multiple samples of joining structure s were produced by joining a pair of joined bodies made of aluminum at the plating portion. The evaluation of joint strength and observation/analysis of joint sections were performed. The first joined body with a composition of 99% AI and the second joined body with 99.5% aluminum (A1050P) were prepared. The first joined body was in the form of a 0.5 mm diameter, 2 mm long wire, while the second joined body was a flat plate with a thickness of 1 mm. Nickel was used as the plating metal constituting the plating portion. The method for preparing the samples was the same as the manufacturing method in the first embodiment.

In the plating process, since both joined bodies were made of aluminum and direct electrolytic nickel plating was difficult, a electroless Ni-10% P plating with a thickness of 1 to 6 μm was applied to the surfaces. After joining the joined bodies with plating, the samples were subjected to heat treatment in the atmosphere. To verify the difference in joint strength due to differences in heat treatment temperature, samples were prepared and subjected to 30 minutes of heat treatment at temperatures of 150° C., 250° C., 350° C., and 450° C. Additionally, samples without heat treatment were also prepared.

The evaluation of joint strength was performed using the same method, conditions, and equipment as in the first example. As a result of shear strength measurements, both the samples without heat treatment and those subjected to 150° C. heat treatment exhibited fractures at the interface between the joined bodies and the plating portion or within the plating portion itself. Some fractures were observed within the joined bodies in the samples subjected to 250° C. heat treatment. In the samples subjected to 350° C. and 450° C. heat treatment, all fractures occurred within the joined bodies. Therefore, it was confirmed that the joint strength increased in the samples with heat treatment temperatures above 250° C. compared to the samples without heat treatment and those with 150° C. heat treatment.

### Example 6

In the sixth example, multiple samples of joining structure s were prepared by joining a pair of joined bodies made of stainless steel at the plating portion, and tensile tests were conducted. The first joined body and the second joined body were made of SUS304 stainless steel. The same samples as in the fourth example were prepared, and both the first and second joined bodies had a thickness of 0.2 mm, with nickel used as the plating metal constituting the plating portion. A Shimadzu Autograph AG-X precision universal testing machine was used for the tensile tests.

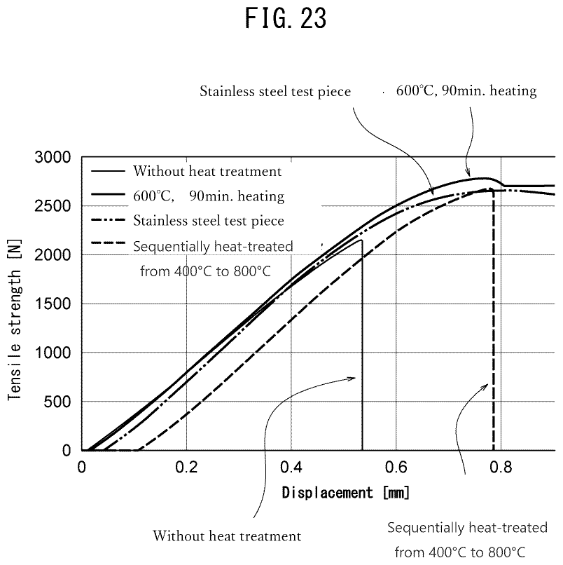

After plating, the samples were subjected to heat treatment in the atmosphere. To verify the difference in tensile strength due to the presence or absence of joining and heat treatment, various samples were prepared: test pieces of stainless steel without joining, samples without heat treatment, and samples subjected to heat treatment at 200° ° C., 250° C., 300° C., 400° C., 500° C., and 600° C. for 90 minutes each. Additionally, samples were sequentially heat-treated at 100° ° C. intervals from 400° C. to 800° C. Three identical samples were prepared for each condition, and the average value of three tensile tests was calculated for each sample. The results are shown in FIG. 23.

In this example, the maximum load of the stainless steel test piece sample was set to 1.0, and the tensile strength was evaluated relative to this value. For samples without heat treatment, the tensile strength was the lowest at 0.81. The samples heat-treated at 200° C. showed a tensile strength of 0.82 (not shown in the graph), those heat-treated at 250° C. showed 0.90 (not shown in the graph), those heat-treated at 300° ° C. showed 0.95 (not shown in the graph), and those heat-treated at 400° C. showed 0.97 (not shown in the graph). Samples subjected to heat treatment at 500° C. or higher, as well as those sequentially heat-treated from 400° C. to 800° C., were all rated as 1.0 due to fractures occurring within the joined bodies. Moreover, it was confirmed that the samples heat-treated at 500° C. or higher exhibited joint strength equivalent to that of the stainless steel test piece samples. From these results, it was confirmed that there was a clear increase in strength in the samples with heat treatment temperatures above 250° C.

### REFERENCE SIGNS LIST

10, 30, 50: Joining structure
12, 32: First joined body
12a, 16a, 32a, 36a, 52a, 58a: Joined surface
32b: Tip portion
14, 34, 54: Plating portion
16, 36: Second joined body
52: Wiring material (joined body)
56: Solar cell (joined body) AI: Interface
MR1: First diffusion region
MR2: Second diffusion region
RC: Recrystallization region

1. A joining structure, comprising:
a first joined body composed of a first metal,
a second joined body composed of a second metal, and
a plating portion, disposed between the first and second joined bodies, formed of a plating metal, and joining the first and second joined bodies,
wherein in the plating portion, a joining interface of integrated plating metal is formed at around equidistance from the respective joined surfaces of the first and second joined bodies, and
the plating portion comprises, in the vicinity of the joining interface, a recrystallization region where the plating metal has recrystallized or a first diffusion region where the plating metal has diffused.

2. A joining structure, comprising:
a first joined body made of a first metal,
a second joined body made of a second metal,
a plating portion, disposed between the first and second joined bodies, formed of a plating metal, and joining the first and second joined bodies, and
a second diffusion region where the metal of at least one of the first and second joined bodies and the plating metal are mixed and diffused, at the boundary between at least one of the first and second joined bodies and the plating portion.

3. The joining structure according to claim 2, wherein the plating portion has a recrystallized region of recrystallized plating metal at around equidistance from the respective surfaces of the first and second joined bodies.

4. The joining structure according to claim 1, wherein the first and second joined bodies make a point or linear contact, or are in close proximity in a point or linear manner.

5. The joining structure according to claim 1, wherein the first and second metals of the first and second joined bodies and the plating metal are identical or all proportional solid solution.

6. The joining structure according to claim 1, wherein the first and second joined bodies are composed of iron alloy, and the plating metal is composed of nickel or nickel alloy.

7. A method of manufacturing a joining structure, comprising:
a connection step for connecting a first joined body and a second joined body with a plating metal by way of immersing a plating solution between the first joined body of first metal and the second joined body of second metal, thereby forming a joining interface of integrated plating metal grown from the respective joined surfaces of the first and second joined bodies, and
a heat-treatment step for heat-treating the plating metal after the connection step,
wherein, in the heat-treatment step, a recrystallization region is formed at the joining interface where the plating metal is recrystallized.

8. A method of manufacturing a joining structure, comprising:
a connection step for connecting a first joined body and a second joined body with a plating metal by way of immersing a plating solution between the first joined body of first metal and the second joined body of second metal, thereby forming a joining interface of integrated plating metal grown from the respective joined surfaces of the first and second joined bodies, and
a heat-treatment step for heat-treating the plating metal after the connection step,
wherein, the heat-treatment temperature T2 in the heat-treatment step satisfies the relation of T2≥T1×⅓ (T1: melting temperature of the plating metal, T1 and T2 are of Kelvin).

9. The method of manufacturing a joining structure according to claim 7, wherein the joining interface disappears in the heat-treatment step.

10. The method of manufacturing a joining structure according to claim 7, wherein in the connection step, the respective joined surfaces of the first and second joined bodies partially make a point or linear contact, or are in close proximity in a point or linear manner, and the joining interface is formed in order from narrow sites to broad sites of the interspace between the respective joined surfaces of the first and second joined bodies.

11. The method of manufacturing a joining structure according to claim 7, wherein a smoothening step is carried out, prior to the connection step, for smoothening the respective joined surfaces of the first and second joined bodies.

12. The joining structure according to claim 2, wherein the first and second joined bodies are composed of iron alloy, and the plating metal is composed of nickel or nickel alloy.

13. The method of manufacturing a joining structure according to claim 8, wherein the joining interface disappears in the heat-treatment step.
